(19) United States
(12) Patent Application Publication
(10) Pub. No.: US 2014/0086105 A1
(43) Pub. Date: Mar. 27, 2014

(54) DEVICE AND METHOD FOR PROVIDING DRAWING SCREEN SHARING SERVICE

(71) Applicant: Pantech Co., Ltd., Seoul (KR)

(72) Inventors: Gap-Chul KANG, Bucheon-si (KR); Ki-Hyun Jeong, Paju-si (KR)

(73) Assignee: Pantech Co., Ltd., Seoul (KR)

(21) Appl. No.: 14/029,205

(22) Filed: Sep. 17, 2013

(30) Foreign Application Priority Data
Sep. 21, 2012 (KR) 10-2012-0105469

(51) Int. Cl. H04L 29/08

(52) U.S. Cl. CPC H04L 67/26
USPC 370/259

(57) ABSTRACT

A method for sharing a drawing screen includes establishing a data communication link between a first mobile terminal and a second mobile terminal using data communication link information, and sharing of a drawing screen of the first mobile terminal with the second mobile terminal using the data communication link. A first mobile terminal to share a drawing screen includes a wireless communication unit to establish a data communication link with a second mobile terminal using data communication link information received from a management server storing registration information of at least one of the first mobile terminal and the second mobile terminal, and a controller to share a drawing screen displayed on the first mobile terminal with the second mobile terminal using the data communication link.

### CROSS-REFERENCE TO RELATED APPLICATION

This application claims priority to and the benefit under 35 U.S.C. §119(a) of Korean Patent Application No. 10-2012-0105469, filed on Sep. 21, 2012, the entire disclosure of which is incorporated herein by reference for all purposes.

### BACKGROUND

1. Field

The following description relates to technology for sharing a drawing screen of a mobile terminal with another mobile terminal.

2. Discussion of the Background

Due to rapid development of information communication technology, a mobile terminal capable of supporting communication, such as a user equipment, continues to evolve. Therefore, existing functions with which the mobile terminal is equipped continue to improve, and the mobile terminal is being equipped with various new functions. A smart phone or a tablet computer, an example of a mobile terminal, is being newly equipped with, for example, a near field communication (NFC) function, a handwriting recognition function, a motion user interface function, a face recognition function, and a smart screen maintaining function.

A touch screen of a mobile terminal may be used as a user interface for the mobile terminal, and a user may input information or data of variety types and formats through the touch screen according to the user's intent, in addition to standardized text or symbols, in accordance with a method or a format provided from the mobile terminal. In particular, the user may input by, for example, direct handwriting or drawing, a symbol or a picture on the touch screen. Further, it is even possible to input by such drawings (for example, handwriting and drawing) under various conditions (for example, while various background images or other applications are running).

Meanwhile, the mobile terminal, such as the smart phone or the tablet computer may support data communication via a data network, as well as a voice or video call provided from a network operator. The user may communicate via the data network with the mobile terminal, and a type of such communication is transmitting and receiving a message with other users using a messenger application. The user executes the messenger application installed in the mobile terminal to deliver a message to other users or to transmit various stored content (for example, image, audio and video content). In this messenger application, a transmitting terminal firstly transmits a message and/or content in addition to identification information on a receiving terminal to a push server, and the push server transmits the received message and/or content to the receiving terminal corresponding to the identification information.

In this way, as communication through the data communication as well as the voice or video call becomes more routine and common, users' demands and needs to express their intentions to others in a variety of other forms besides voice or text are increasing. For example, users may seek to deliver drawings (for example, handwriting or pictures) created by themselves on the touch screen of the mobile terminal. That is, effective information delivery may be accomplished, such that a user may express his or her emotions with a predetermined picture (for example, a heart display) or handwritten text to others, or the user may view the same background as others, for example, a map, so as to provide guidance by indicating a destination or a movement path.

As an example, a technique of transmitting a drawing pattern created in a mobile terminal to another mobile terminal is disclosed in “terminal and drawing pattern transmitting method using the same,” Korean Unexamined Patent Application Publication No. 2010-0032091. In this technique, when the user performs a pointing action while performing a video calling operation with the mobile terminal, the mobile terminal recognizes this action and creates a drawing pattern, and the created drawing pattern is coupled with a video call image and transmitted to others. As a result, in order to transmit the drawing pattern to others using the mobile terminal, it is necessary for the user to engage in a video calling operation with others over a video channel of the network provider, that is, it is necessary to maintain connection over the video channel. Accordingly, when the video calling operation is terminated, the drawing pattern can no longer be transmitted. Moreover, since data processing to couple the drawing pattern and the video call image is essential, it is difficult to transmit various drawing patterns in real time, to correct or delete a drawing pattern once transmitted to others, and to redo a deleted drawing pattern.

### SUMMARY

Exemplary embodiments of the present invention provide a device and method for sharing a drawing screen.

Additional features of the invention will be set forth in the description which follows, and in part will be apparent from the description, or may be learned by practice of the invention.

Exemplary embodiments of the present invention provide a method for sharing a drawing screen including establishing a data communication link between a first mobile terminal and a second mobile terminal using data communication link information; and sharing of a drawing screen of the first mobile terminal with the second mobile terminal using the data communication link.

Exemplary embodiments of the present invention provide a first mobile terminal to share a drawing screen including a wireless communication unit to establish a data communication link with a second mobile terminal using data communication link information received from a management server storing registration information of at least one of the first mobile terminal and the second mobile terminal; and a controller to share a drawing screen displayed on the first mobile terminal with the second mobile terminal using the data communication link.

Exemplary embodiments of the present invention provide a system to share a drawing screen of a first mobile terminal with a second mobile terminal including a management server to receive a request for sharing a drawing screen from the first mobile terminal, to select a relay server for relaying data between the first mobile terminal and the second mobile terminal, is to transmit data communication link information to the relay server and the first mobile terminal, to transmit a push request message for connecting with the second mobile terminal to a push server; the push server to transmit, to the second mobile terminal, a connection-inducing message including at least a portion of the data communication link information; and the relay server to establish a connection between the first mobile terminal and the second mobile terminal according to the data communication link information for sharing the drawing screen of the first mobile terminal with the second mobile terminal.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a configuration of a device to provide a to drawing screen sharing service according to an exemplary embodiment of the present invention.

FIG. 2 is a block diagram illustrating a configuration of a mobile terminal according to an exemplary embodiment of the present invention.

FIG. 3 is a flowchart illustrating a procedure in which a mobile terminal registers a service in a service providing device according to an exemplary embodiment of the present is invention.

FIG. 4A is a flowchart illustrating a procedure in which two mobile terminals set a wireless data communication link according to an exemplary embodiment of the present invention.

FIG. 4B is a flowchart illustrating a procedure in which two mobile terminals share drawing information over the wireless data communication link set in FIG. 4A according to an exemplary embodiment of the present invention.

FIG. 5 is a diagram illustrating a message including drawing information according to an exemplary embodiment of the present invention.

FIG. 6 is a flowchart illustrating a procedure for terminating a service registration on a mobile terminal according to an exemplary embodiment of the present invention.

FIG. 7A, FIG. 7B, FIG. 7C, FIG. 7D, FIG. 7E, FIG. 7F, FIG. 7G, FIG. 7H and FIG. 7I are diagrams illustrating user interfaces displayed on a touch screen of a mobile terminal using a drawing screen sharing service according to exemplary embodiments of the present invention.

### DETAILED DESCRIPTION OF THE ILLUSTRATED EMBODIMENTS

The invention is described more fully hereinafter with reference to the to accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed is as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

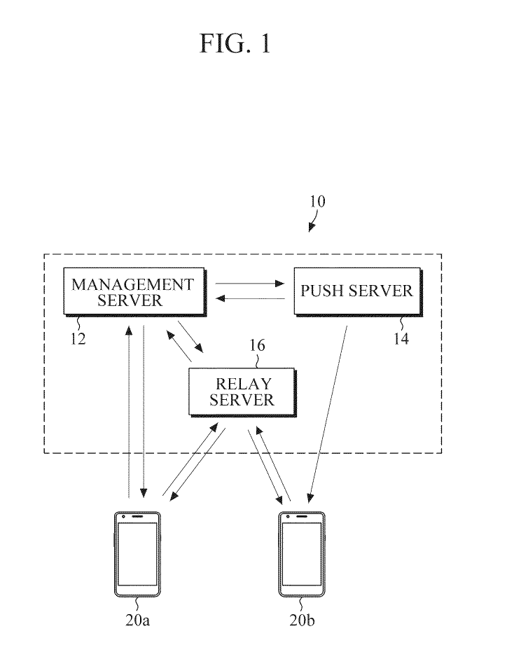

FIG. 1 is a block diagram illustrating a configuration of a device to provide a drawing screen sharing service according to an exemplary embodiment of the present invention.

A drawing screen sharing system 10 illustrated in FIG. 1 may be a system in which the drawing screen of a mobile terminal is shared with another mobile terminal. For example, a drawing screen of the first mobile terminal 20A may be displayed on another mobile terminal, for example, the second mobile terminal 20B in real time. The drawing screen sharing system 10 may set a wireless data communication link for data communication with the second mobile terminal 20B according to a connection request from either one of the first mobile terminal 20A and the second mobile terminal 20B, for example, the first mobile terminal 20A. The drawing screen sharing system 10 may support transmission of drawing information, which may also include background data, from the first mobile terminal 20A to the second mobile terminal 20B and/or from the second mobile terminal 20B to the first mobile terminal 20A over the set data communication link. Hereinafter, the system will be described in more detail.

As illustrated in FIG. 1, the drawing screen sharing system 10 includes a management server 12, a push server 14, and a relay server 16. In FIG. 1, although the drawing screen sharing system 10 is illustrated as having a single management server 12, push server 14 and relay server 16, aspects of the invention are not limited thereto, such that the drawing screen sharing system 10 may include a plurality of management servers 12, push servers 14, and/or relay servers 16.

The configuration of the drawing screen sharing system 10 illustrated in FIG. 1 is logically divided based on its operation or role, and one or more of the management server 12, the push server 14, and the relay server 16 may be physically integrated or separately implemented. For example, some or all of the management server 12, the push server 14, and the relay server 16 may be integrated and implemented as one or two servers. Further, a message transmission process among the management server 12, the push server 14, and the relay server 16 described below may be replaced by a signal transmission process among various units or modules in the server, or signal transmission itself may be unnecessary when various operations of the servers are integrated. According to aspects of the invention, the drawing screen sharing system 10 is not limited to the configuration illustrated in FIG. 1, such that, an operation of a server included in the drawing screen sharing system 10 may be performed by another server, without limitation. Furthermore, an operation of one or more servers included in the drawing screen sharing system 10, including the management server 12, the push server 14, and the relay server 16 may be performed by two or more servers in the drawing screen sharing system 10 in a distributed manner.

In addition, one or more of the servers configuring the drawing screen sharing system 10, including the management server 12, the push server 14, and the relay server 16, may not be located in the same physical place, or may not be held or managed by the same service provider. For example, a service provider, who may provide a drawing screen sharing service according to an exemplary embodiment of the invention, may hold only the management server 12 and the relay server 16, but the push server 14 may be held by a different service provider who provides a message push service. Further, the provider of the drawing screen sharing service may provide the drawing screen sharing service according to an exemplary embodiment of the present invention by utilizing the push server 14 held and managed by another provider. Although the sharing of a drawing screen displayed on a mobile terminal is described, aspects of the invention are not limited thereto, such that sharing of an editable image, document, and the like may be similarly performed.

As described above, the management server 12, the push server 14, and the relay server 16 may be integrated and implemented in one server, for example, a drawing screen is sharing server (not illustrated). Further, the drawing screen sharing server may receive a service request from the first mobile terminal 20A to share the drawing screen with the second mobile terminal 20B and may process it internally. More specifically, when the service request is received from the first mobile terminal 20A, the drawing screen sharing server may transmit a push-type connection-inducing message to the second mobile terminal 20B. By respectively responding to the connection request received from the first mobile terminal 20A and a connection request received from the second mobile terminal 20B in response to the connection-inducing message, the drawing screen sharing server may set and manage the data communication link to transmit the drawing information for sharing the drawing screen between the first mobile terminal 20A and the second mobile terminal 20B. The drawing screen sharing system 10 may communicate with each of the first mobile terminal 20A and the second mobile terminal 20B via a data network. Examples of the data network include, without limitation, a code division multiple access (CDMA) data network, a global system for mobile communication (GSM) data network, a wideband code division multiple access (WCDMA) data network, a long term evolution (LTE) data network, WiBro®, WiMAX®, and Wi-Fi®. Since a procedure of providing the drawing screen sharing service according to exemplary embodiments of the invention described below may be performed via the data network, the first mobile terminal 20A may perform a voice or video call with the second mobile terminal 20B, or vice versa, over the voice/video communication channel of the network operator, even when the corresponding service is in use.

The management server 12 may perform one or more management operations to provide a drawing screen sharing service. The management server 12 may perform, for example, a task of managing registration or termination of services with respect to the first mobile terminal 20A and/or the second mobile terminal 20B, a task of communicating with the push server 14 to push a message to the first mobile terminal 20A and/or the second mobile terminal 20B, a task of setting the wireless data communication link between the first mobile terminal 20A and the second mobile terminal 20B, selecting the relay server 16 to transmit the message over the set link, and a task of managing session identifiers (IDs). Hereinafter, one or more of these tasks will be described in more detail.

The management server 12 may perform registration or termination of services with respect to at least one of the first mobile terminal 20A and the second mobile terminal 20B according to requests of the at least one of the first mobile terminal 20A and the second mobile terminal 20B. More specifically, when there are service registration requests from at least one of the first mobile terminal 20A and the second mobile terminal 20B, the management server 12 may perform a respective service registration procedure by receiving respective identification information, which may include, a phone number or a terminal ID (e.g., mobile equipment identifier (MEID) or international mobile equipment identity (IMEI)), from the at least one of the first mobile terminal 20A and the second mobile terminal 20B. When there are requests for service terminations from at least one of the first mobile terminal 20A and the second mobile terminal 20B that have registered for the service, the management server 12 may receive identification information, for example, a phone number with authentication information, from the at least one of the first mobile terminal 20A and the second mobile terminal 20B. Further, the management server 12 may proceed with the termination procedure for the at least one of the first mobile terminal 20A and the second mobile terminal 20B.

According to exemplary embodiments, there is no specific limitation in a procedure in which the management server 12 may perform registrations of services or is terminations of the registered services for at least one of the first mobile terminal 20A and the second mobile terminal 20B. For example, common processes (e.g., a provision consent procedure, a registration procedure of fee payment methods, a consent procedure for providing user information, and a registration procedure of e-mail information) performed in registration or termination of the mobile terminal in order to provide other services via the data network may be similarly applied to the procedures in registration or termination of services by the management server 12.

According to exemplary embodiments, when requests for service registrations or terminations are received from at least one of the first mobile terminal 20A and the second mobile terminal 20B, the management server 12 may perform a procedure of requesting registration or termination of message push services with respect to the at least one of the first mobile terminal 20A and the second mobile terminal 20B to the push server 14. Registration in the push server 14 may transmit a push-type message inducing a connection of the second mobile terminal 20B to the second mobile terminal serving as the peer terminal when the service request is received from either one of the first mobile terminal 20A and/or the second mobile terminal 20B (e.g., the first mobile terminal 20A). When the management server 12 is capable of providing the message push service, the management server 12 may not request push registrations or terminations with respect to at least one of the first mobile terminal 20A and the second mobile terminal 20B to the push server 14.

The management server 12 may also store and manage information on at least one of the first mobile terminal 20A and the second mobile terminal 20B to provide services or created in the service providing process. The management server 12 may store and manage, for example, provisional terms and condition information, identification information, such as a is phone number, a terminal ID, authentication information, and payment information of at least one of the first mobile terminal 20A and the second mobile terminal 20B. In addition, the management server 12 may also store and manage additional information, for example, those that may be created in the service use of at least one of the first mobile terminal 20A and the second mobile terminal 20B or those that may be referenced to provide services (e.g., service usage history, and a usage time).

When the management server 12 receives a service request from either one of the first mobile terminal 20A and the second mobile terminal 20B, for example, the first mobile terminal 20A transmitting a request for the drawing screen sharing service with the second mobile terminal 20B, the management server 12 may select the relay server 16, which may transmit data between the first mobile terminal 20A and the second mobile terminal 20B, among a plurality of relay servers (not illustrated). There is no specific limitation in selecting the relay server by the management server 12. For example, network condition (e.g., network congestion) or service policy of one or more relay servers may be considered.

The management server 12 may transmit information for setting the wireless data communication link between two mobile terminals, such as the first mobile terminal 20A and the second mobile terminal 20B. For example, the management server 12 may transmit a session ID, to at least one of the first mobile terminal 20A, the second mobile terminal 20B, and the selected relay server 16. The connection request message, which may be received by the relay server 15 from at least one of the first mobile terminal 20A and the second mobile terminal 20B, may include the session ID. The relay server 16 may use link identification information, such as the session ID, to match the first mobile terminal 20A and the second mobile terminal 20B and set the wireless data communication link.

The push server 14 may be a device that provides a message push service with respect to the first mobile terminal 20A and the second mobile terminal 20B. The push server 14 may manage at least one of the first mobile terminal 20A and the second mobile terminal 20B to receive the push service message according to requests for push service registration or termination from the management server 12. In addition, the push server 14 may store and manage information on at least one of the first mobile terminal 20A and the second mobile terminal 20B that have registered for the push service. The push server 14 may transmit a push-type connection request message to induce a connection with the relay server 16 to at least one of the first mobile terminal 20A and the second mobile terminal 20B in accordance with the request from the management server 12. The push server 14 may also transmit information that may be used by one of the mobile terminals, such as the first mobile terminal 20A, to request connection with another terminal, such as the second mobile terminal 20B, to the relay server 16. For example, the push server 14 may transmit a session ID corresponding to at least one of the first mobile terminal 20A and the second mobile terminal 20B to the relay server 16.

The relay server 16 may support data communication between the first mobile terminal 20A and the second mobile terminal 20B, to share the drawing screen between the first mobile terminal 20A and the second mobile terminal 20B. More specifically, the relay server 16 may relay communication between the first mobile terminal 20A and the second mobile terminal 20B to transmit, for example, at least one of drawing information, drawing change requests, and background data. Further, the relay server 16 may set the wireless data communication link between the first mobile terminal 20A and the second mobile terminal 20B in response to the connection request from some or all of the first mobile terminal 20A and the second mobile terminal 20B. In order to authenticate and match the first mobile terminal 20A and the second is mobile terminal 20B to be linked, the relay server 16 may use identification and authentication information, for example, session ID, received from the management server 12.

After the data communication link is set or established, the relay server 16 may manage the set data communication link to be maintained continuously. According to aspects of the invention, the data communication involved in the drawing screen sharing process may be performed over the data communication link set between the first mobile terminal 20A and the second mobile terminal 20B.

Further, the relay server 16 may monitor whether a network connection with the first mobile terminal 20A and the second mobile terminal 20B is maintained in the network layer based on common monitoring protocols. In addition, according to aspects of the invention, the relay server 16 may check whether the set link is maintained continuously by transmitting and receiving the control packet in a periodic manner with each of the first mobile terminal 20A and the second mobile terminal 20B in the application layer. The first mobile terminal 20A and the second mobile terminal 20B may be informed of an abnormal disruption in the connections between the relay server 16 and at least one of the first mobile terminal 20A and the second mobile terminal 20B. For example, abnormal disruption may include, without limitation, power or an operating system of at least one of the first mobile terminal 20A and the second mobile terminal 20B shutting down, or at least one of the first mobile terminal 20A and the second mobile terminal 20B moving into an area with limited data communication service.

The network monitoring may be performed in the application layer and specific method thereof may be variously implemented. For example, the relay server 16 may check whether the control packet is periodically received from at least one of the first mobile terminal 20A and the second mobile terminal 20B. Further, the relay server 16 may transmit the control is packet to at least one of the first mobile terminal 20A and the second mobile terminal 20B and check whether a corresponding response is received from the at least one of the first mobile terminal 20A and the second mobile terminal 20B. According to aspects of the invention, there is no specific limitation on the period in which the control packet may be transmitted and/or received. The period may be a fixed or variable in consideration of various factors, which may include at least one of a network condition, performance of at least one of the first mobile terminal 20A and the second mobile terminal 20B, communication load, and battery states.

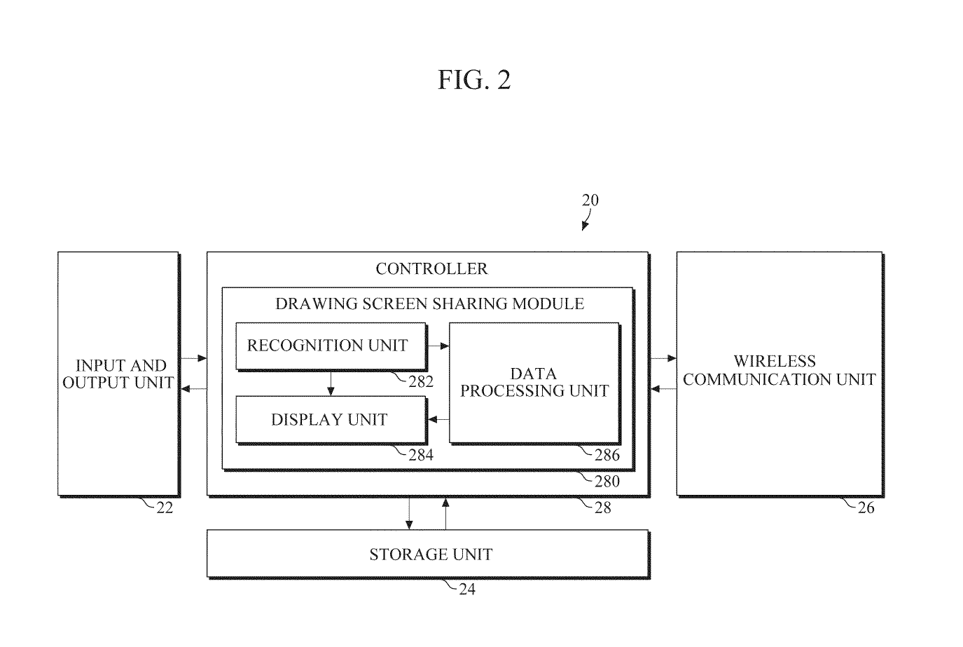

FIG. 2 is a block diagram illustrating a configuration of a mobile terminal according to an exemplary embodiment of the present invention.

A mobile terminal 20 illustrated in FIG. 2 may be similar to at least one of the first mobile terminal 20A and the second mobile terminal 20B of FIG. 1. This mobile terminal 20 may be a smart mobile device having a predetermined mobile operating system (mobile OS), for example, Android®, iOS®, and Windows Mobile®, installed thereon, that may control operations, instruct, and adjust processing of embedded functions or installed applications.

Further, although not shown in FIG. 2, a mobile terminal may include hardware components, such as one or more processors, a camera, a speaker, and the like. Also, the units, modules, elements, devices, applications, and components of the apparatuses, systems, and/or mobile terminals herein described, may include hardware and software, may also include firmware, to perform various operations of the terminal including those described herein, may be combined or remain separate, and may be stored in one or more storage devices or computer-readable media. And, although described herein as a mobile terminal, aspects need not be limited thereto such that the mobile terminal may be a cellular telephone, a smartphone, a tablet computer, a laptop computer, a desktop computer, and the like.

Moreover, the mobile terminal 20 may be, for example, a smart phone or a tablet computer that supports data communication and/or a voice or video call via a mobile communication network. The mobile terminal 20 may simultaneously perform the data communication and the voice call. For example, the mobile terminal 20 may additionally perform the voice or video call with the same mobile terminal in addition to data transmitting over the wireless data communication link set with another mobile terminal.

However, aspects of the invention are not limited to the mobile terminal that supports both types of communication. For example, the mobile terminal 20 may be a mobile terminal, which may support only data communication via a predetermined data network, for example, Wi-Fi®, and not the voice or video call. Further, the drawing screen sharing system 10 of FIG. 1 may identify the mobile terminal 20 using information other than the phone number or using information associated with the mobile phone number of the user. As an example of the latter, a user who uses a tablet computer having no mobile communication chips but having a Wi-Fi® chip may use both terminal identification information of the tablet computer and/or the mobile phone number held or used by the user to identify and authenticate the tablet computer.

As illustrated in FIG. 2, the mobile terminal 20 includes an input and output unit 22, a storage unit 24, a wireless communication unit 26, and a controller 28 having a drawing screen sharing module 280. FIG. 2 illustrates an exemplary configuration of the mobile terminal that can share the drawing screen with another mobile device. However, aspects of the invention are not limited thereto, such that the mobile terminal 20 may not include all of modules illustrated in FIG. 2, and one or more modules may not be included. Among the wireless communication modules, which may correspond to the wireless communication unit 26, for example, a mobile communication module (3G/4G), a Wi-Fi® module, a Bluetooth® module, and a near field communication (NFC) module, all or some of other wireless communication modules other than the mobile communication module and/or the Wi-Fi® module may not be included in the mobile terminal 20. Further, the mobile terminal 20 may further include other modules that may be used for operation thereof, and the modules to be added may differ based on, for example, a type, a configuration, or an operation of the mobile terminal 20. The mobile terminal 20 may further include, for example, a gravity sensor, a proximity sensor, and/or a sensor module, such as an acceleration sensor, a vibration generating module, a global positioning system (GPS) module, a digital multimedia broadcasting (DMB) module, and a camera module.

The input and output unit 22 may input, for example, data and signals, to the mobile terminal 20, and may output, for example, the data and the signals processed in the mobile terminal 20. Examples of the input and output unit 22 may include, without limitation, as the input unit, a camera that may capture images or video signals, a microphone that may capture voices or sound, a keypad that may receive data or command inputs by the user, a dome switch, a button, a jog wheel, and a touch pad. Examples of the input and output unit 22 may include, without limitation, as the output unit, a display that may output video signals and a speaker that may output audio signals.

An example of the input and output unit 22 may include a touch screen. The touch screen may be a type of input and output unit that may support interaction between the user and the mobile terminal 20. The touch screen may have a stacked structure in which the touch pad serving as the input unit and the display serving as the output unit are combined, or an integrated structure in which both units are integrally formed. The user may input a command or information, which may include drawing patterns, for example, handwriting and figures, to the is mobile terminal 20, such that the user may touch the touch screen directly or indirectly, by using a stylus pen. The mobile terminal 20 may output at least one of text, drawing patterns, images, and/or videos through the touch screen for the user.

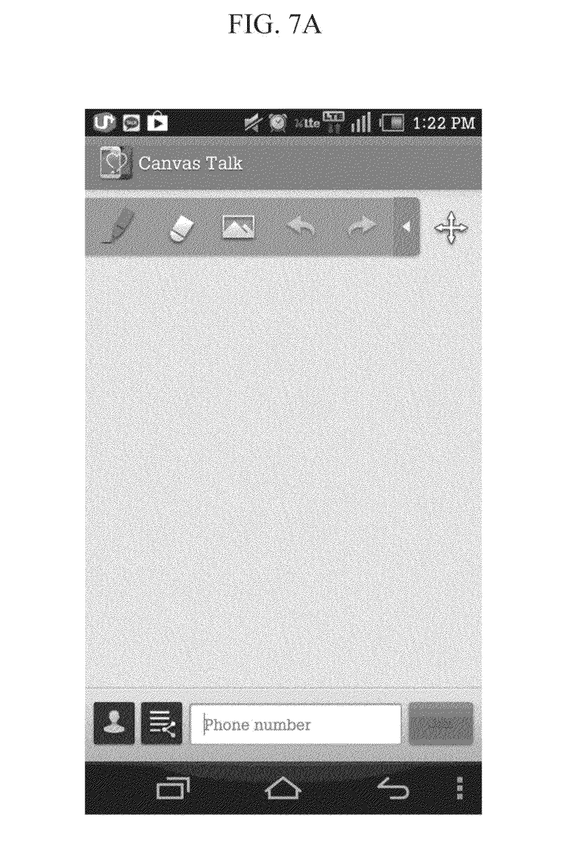

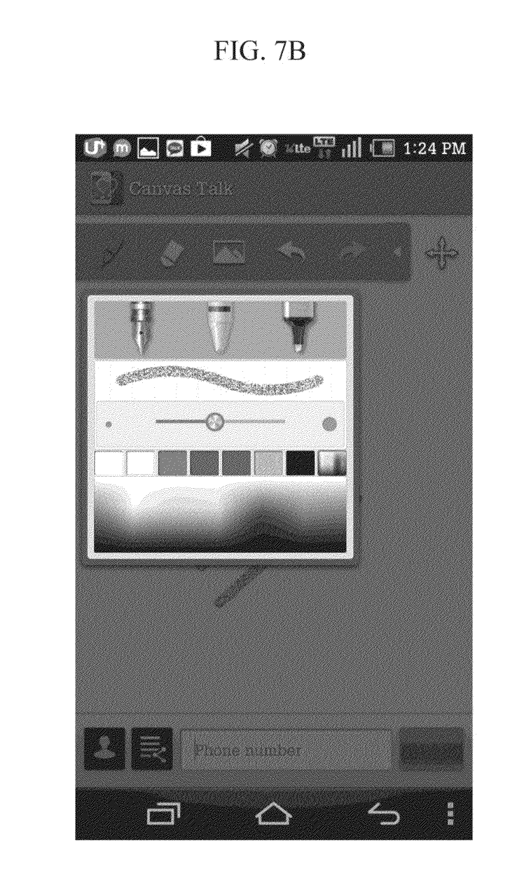

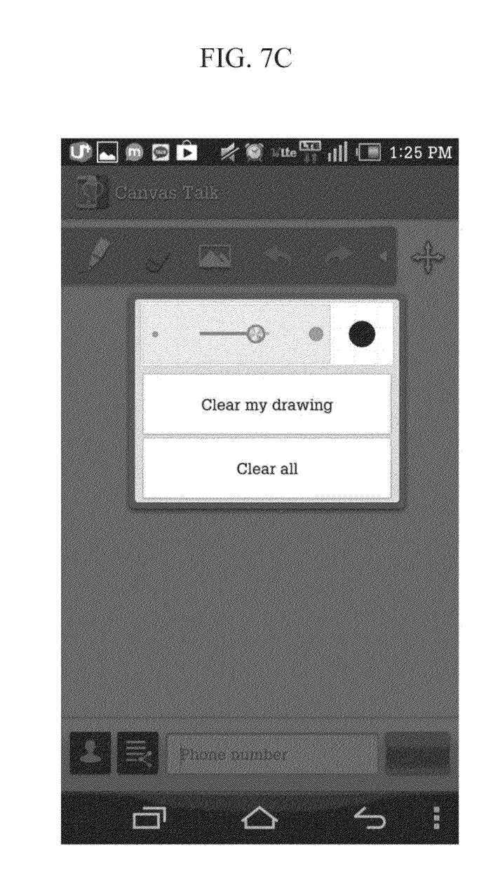

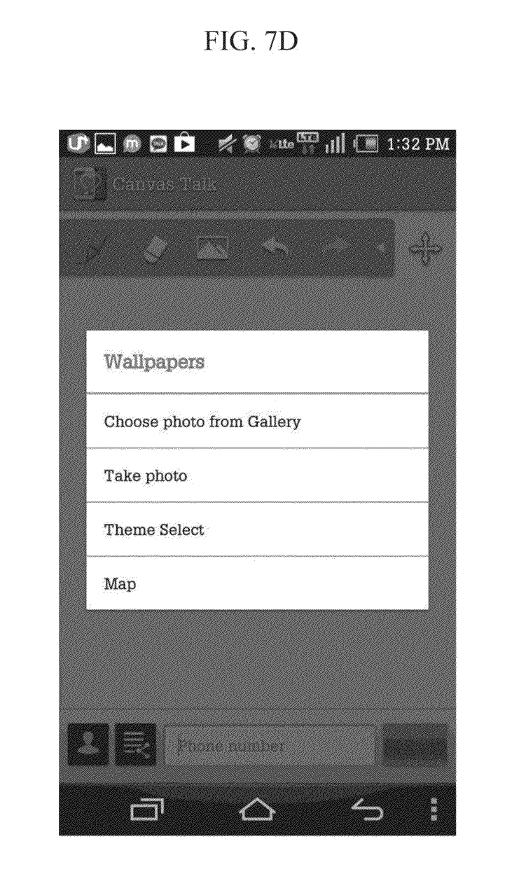

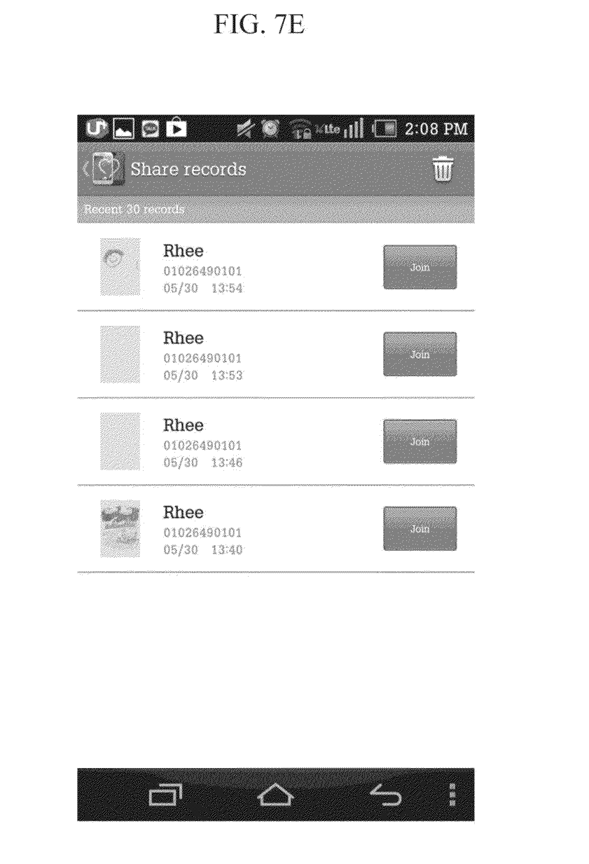

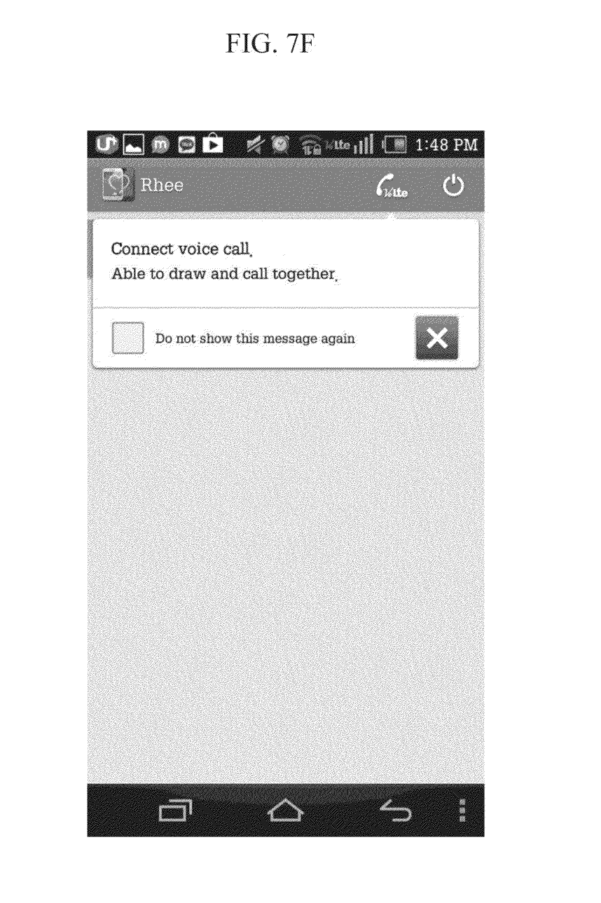

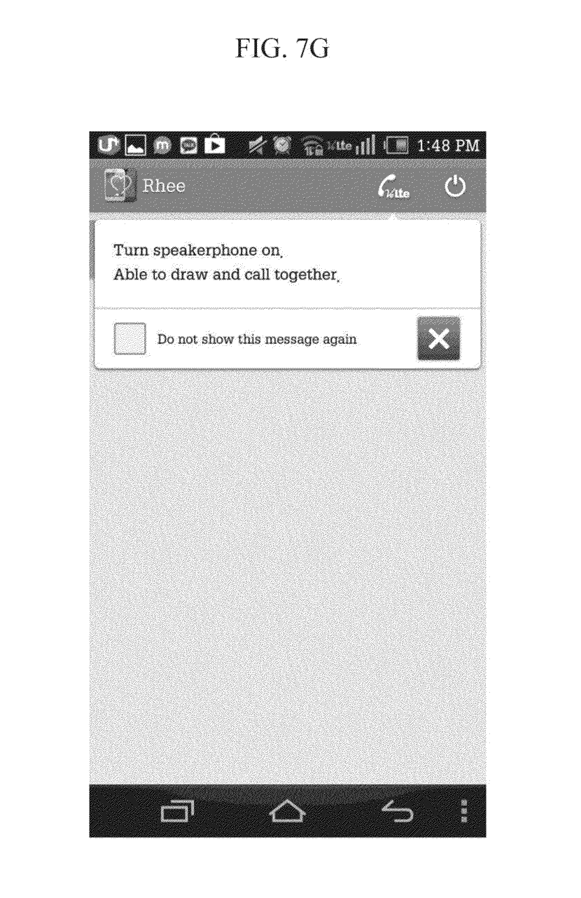

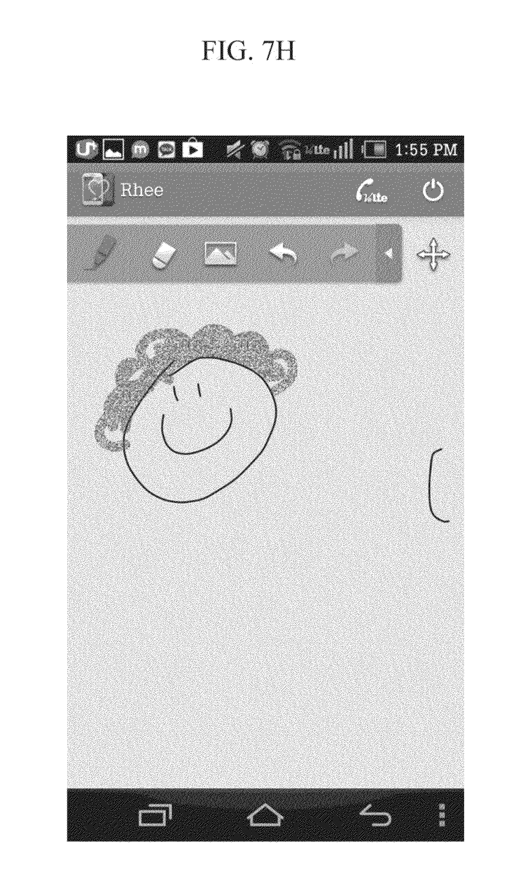

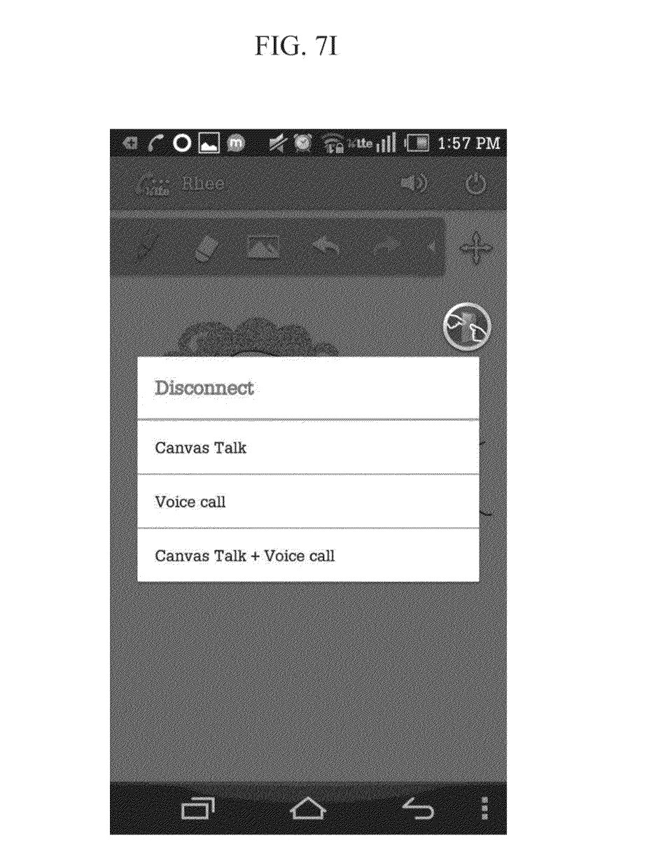

When the user of the mobile terminal 20 attempts to share the drawing screen by transmitting the drawing information to another mobile terminal, various user interfaces (UI) based on executing a drawing screen sharing function or a drawing screen sharing application, without limitation, may be displayed on the touch screen of the mobile terminal 20 (see FIG. 7A, FIG. 7B, FIG. 7C, FIG. 7D, FIG. 7E, FIG. 7F, FIG. 7G, FIG. 7H, and FIG. 7I). The user may touch the touch screen on which a predetermined user interface may be displayed to select a predetermined menu or input command, or to create a predetermined drawing pattern on the background image (see FIG. 7H). Moreover, when the mobile terminal 20 receives the drawing information from a transmitting mobile terminal, the same drawing pattern displayed on the touch screen of the transmitting mobile terminal may be displayed on the touch screen of the mobile terminal 20. Hereinafter, with reference to FIG. 7A, FIG. 7B, FIG. 7C, FIG. 7D, FIG. 7E, FIG. 7F, FIG. 7G, FIG. 7H, and FIG. 7I, examples of the UI that can be displayed on the touch screen according to executing the mobile screen sharing application by the mobile terminal 20 will be described.

FIG. 7A is a diagram illustrating a UI which may be displayed on the touch screen of the mobile terminal 20 when the mobile terminal 20 of FIG. 2 executes the drawing screen sharing operation or the drawing screen sharing application. In FIG. 7A, a graphic image icon and text e.g., graphic image+‘Canvas Talk’) located below a status display bar are displayed on an upper portion of the display of the mobile terminal 20. The displayed image and text may refer to an icon and a name of the corresponding application, respectively. A menu box below is the graphic image and the text displays various icons that may correspond to various menus for the application execution. Referring to FIG. 7A, from left side of FIG. 7A to right side of FIG. 7A, a style setting menu icon, which may be used to set a style of the drawing pattern, an eraser menu icon, a background image menu icon, a undo icon, and a redo icon may be displayed. However, aspects of the invention are not limited thereto, such that additional menu icons may be displayed. A connection request menu may be provided towards the bottom of the display screen to allow selection of a contact to perform drawing screen sharing operation and/or inputting of a phone number or other identification information. Referring to FIG. 7A, the phone number may be used to request connection with the terminal corresponding to the inputted phone number to share the drawing screen, however, aspects of the invention are not limited thereto, such that name, terminal identification, and the like may be used to identify the terminal to perform drawing screen sharing operation.

FIG. 7B illustrates a UI displayed on the display when the user selects the style setting menu icon in FIG. 7A. More specifically, in FIG. 7B, menus to select a pen style or type, colors, and thicknesses by the user are displayed as a graphical UI to set or edit the style of the drawing pattern.

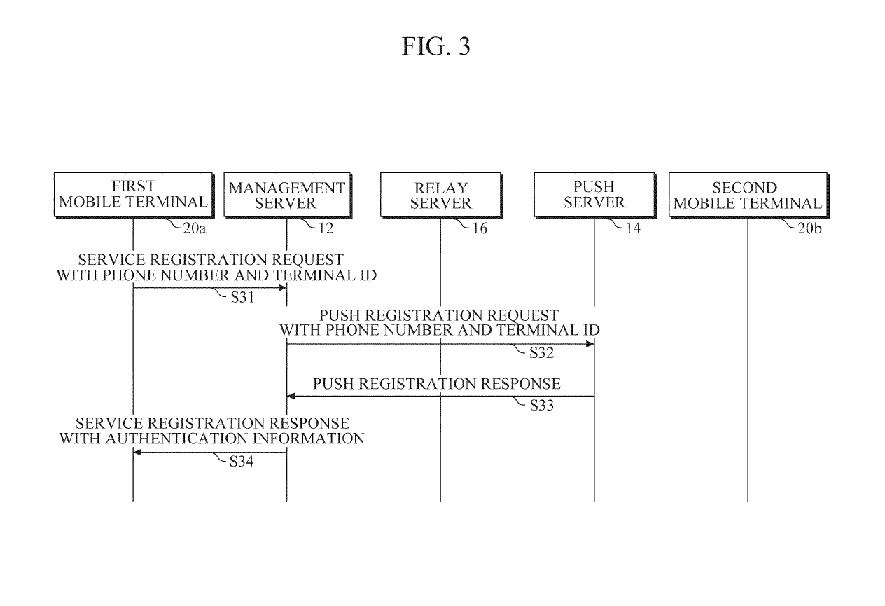

In addition, FIG. 7C illustrates a UI displayed on the display when the user selects the eraser menu icon in FIG. 7A. More specifically, a menu to set the thickness (e.g., width) of the eraser may be displayed in a graphical UI to erase all or a part of a created drawing pattern in FIG. 3C.

FIG. 7D illustrates a UI displayed on the display when the user selects the background image menu icon in FIG. 7A. More specifically, FIG. 7B illustrates a menu list to allow a selection of a background type to select the background image. According to aspects of is the invention, when the user touches any one of menu items displayed on the menu list, a procedure to browse or create (e.g., photograph) the corresponding background screen may be conducted.

FIG. 7E illustrates a UI that may be displayed when the user selects a recent list menu icon (e.g., which may be a second menu icon from the left side) in FIG. 7A. More specifically, when the recent list menu icon of FIG. 7A is selected, the identification number (e.g., phone number) list of mobile terminals that have previously shared the drawing screen by executing the corresponding application, and the connection request menu with respect to these mobile terminals, are displayed in FIG. 7E.

FIG. 7F and FIG. 7G illustrate a UI that may be displayed on the display of the mobile terminal after the wireless data communication link is set to transmit or receive data to or from another terminal through the relay server 16 of FIG. 1. As illustrated in FIG. 7F and FIG. 7G, the mobile terminal may additionally connect the voice call even if the wireless data communication link is set with the other terminal. The UI displayed after the wireless data communication link has been set with the other mobile terminal includes a menu (see FIG. 7F) for connecting the voice call with the other terminal and a menu (see FIG. 7G) for switching the connected voice call to a speaker phone.

FIG. 7H illustrates a drawing screen on which a drawing pattern is displayed on a display unit of the mobile terminal after the wireless data communication link has been set to transmit or receive data with another terminal through the relay server 16 of FIG. 1. FIG. 7H illustrates at least five or more units of drawing patterns having various figure shapes included in the displayed drawing screen of the mobile terminal. However, aspects of the invention are not limited to that displayed in FIG. 7H, such that it may include, without limitation, various kinds of handwriting, figures, or symbols (e.g., drawing patterns) created by the user or displayed on a background image (e.g., maps or photos) selected by the user. Although a drawing figure is illustrated as a drawing pattern in FIG. 7H, aspects of the invention are not limited thereto, such that the drawing pattern may be a line having a particular length, or a point having a single coordinate.

FIG. 7I illustrates a UI for terminating a network connection with the other terminal after the wireless data communication link has been set to transmit or receive data with the other terminal through the relay server 16 of FIG. 1. The UI illustrated in FIG. 7I may be displayed when the voice call is additionally connected with the other terminal. As illustrated in FIG. 7I, a menu for terminating at least one of data communication connection (e.g., Canvas Talk, and the Voice call) is displayed on the display unit. More specifically, Canvas Talk, Voice call, and Canvas Talk+Voice call operations or data communication connections are listed for selection. The user may terminate the connection of the selected data communication connection by selecting one of the listed items in the corresponding menu.

Referring again to FIG. 2, the storage unit 24 may store one or more computer programs used to manage or execute the mobile terminal 20. More specifically, the storage unit 24 may store a variety of computer programs to be processed and controlled by the controller 28, for example, an operating system program, a plurality of operation module programs, and application programs. In addition, the storage unit 24 may store data or information, for example, mail, text, images, videos, documents, music, phone numbers, phone call history, and messages. Moreover, the storage unit 24 may also store the drawing information and/or the background data transmitted or received according to the drawing screen sharing procedure or operation. A type of the storage unit 24 may include, without limitation, a random access is memory (RAM), a built-in or an external flash memory, a magnetic disk memory, and a read only memory (ROM).

The wireless communication unit 26 may be a unit to communicate by transmitting or receiving electromagnetic waves via the wireless communication network, and/or to perform direct communication with another mobile terminal. The wireless communication unit 120 may include a wireless data communication module for data communication, such as, a 3G/4G module, and/or a Wi-Fi® communication module. In addition, the wireless communication unit 26 may include one or more other wireless communication modules, for example, a voice call module, a video call module, a peer-to-peer (P2P) module, a near field communication (NFC) module, such as a Bluetooth® module, a Zigbee® module, and a Wi-Fi direct module. According to aspects of the invention, the mobile terminal 20 may transmit or receive at least one of a request for registration or termination of the drawing screen sharing service and/or the response thereto, a request for the drawing screen sharing service and/or the response thereto, a request for the drawing information, the background data, and the drawing change, through the wireless communication unit 26.

The controller 28 may perform one or more management or processing operations, and control various operations of the mobile terminal 20. For example, the controller 28 may perform a predetermined process in response to user input signals, request signals, or drawing inputs received from the input module of the input and output unit 22. For example, the touch screen on which the UI for the drawing screen sharing is displayed may be the input module of the input and output unit 22. Furthermore, the controller 28 may control the processing result of the input signal or the overall execution result of the controller 28, for example, the received drawing information processed by a data processing unit 286, to be is displayed on the touch screen serving as the output module of the input and output unit 22.

The controller 28 may perform control and signal processing such that the mobile terminal 20 may communicate with the server or another mobile terminal by, for example, data transmitting, data receiving, or voice calls. The controller 28 may include a wireless communication controller (not shown). The wireless communication controller may control one or more of communication modules (e.g., a 3G/4G mobile communication data communication module, a Wi-Fi® module, a 3G/4G mobile communication voice/video communication module, a Bluetooth® module, and a Zigbee® module) provided in the wireless communication unit 26, and process signals transmitted or received thereby.

The controller 28 may perform control such that predetermined operations or applications (e.g., data communication, voice/video calls, games, multimedia reproducing, and Internet access) provided or installed in the mobile terminal 20 are executed. The controller 28 may perform control and signal processing such that running operations or applications are managed. For example, the controller 28 may perform control, signal processing, and data processing to share the drawing screen with another mobile terminal, and the controller 28 may include the drawing screen sharing module 280. All or some operations of the drawing screen sharing module 280 described below may be implemented as an embedded application with which the mobile terminal 20 is originally equipped by its manufacturer, and/or as an arbitrary application on the market that is installed by the user. As illustrated in FIG. 2, the drawing screen sharing module 280 includes a recognition unit 282, a display unit 284, and a data processing unit 286.

The recognition unit 282 may recognize the drawing pattern input by the user in predetermined units. For example, when the user performs a drawing operation on the is predetermined UI (e.g., FIG. 7H) of corresponding application displayed on the touch screen, the recognition unit 282 may recognize the drawing pattern according to the drawing task in units of strokes. The units of strokes may refer to units of individual drawing operations performed while the user maintains contact with the touch screen. When one drawing pattern is completed by a plurality of strokes, the recognition unit 282 may separately recognize the corresponding drawing pattern based on the strokes.

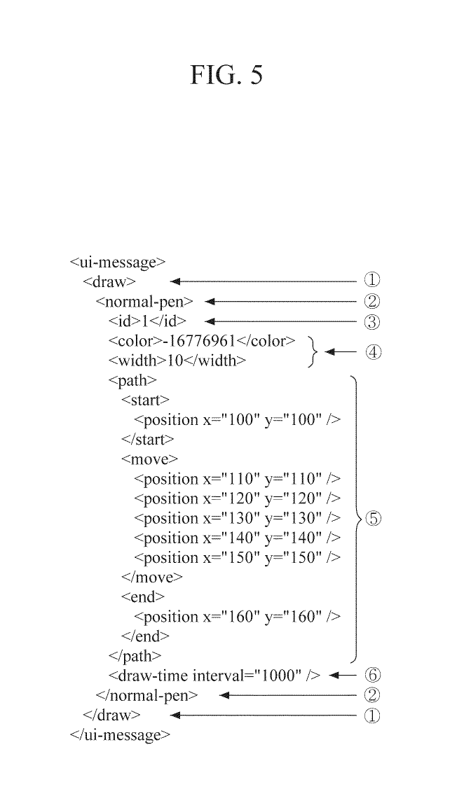

The recognition unit 282 may recognize the units of strokes, and give an identification code (e.g., drawing ID) for one or more drawing patterns corresponding to the recognized units of strokes. The given identification code may be utilized to identify a particular drawing pattern to change (e.g., delete, undo, and redo) already transmitted drawing pattern or information. The identification code may be included in the message (e.g., item \textcircled{3} in FIG. 5) created by the data processing unit 286. The message may be created by receiving the drawing information recognized by the recognition unit 282 and transmitted to another mobile terminal.

The recognition unit 282 may recognize information on, for example, a style or type of pen used, colors, thicknesses, and time operation was performed, used for the drawing operation. According to aspects of the invention, the style or type of pen may be one of various pre-set types of pen (e.g., a pencil, a brush, a fountain pen, and a crayon) (see FIG. 7B). Further, the style or type of pen may include an eraser (see FIG. 7C). The drawing information for erasing all or a part of a created drawing pattern may specify the style or type of pen as the eraser, but formats thereof may be the same as the drawing information on the drawing pattern created by the pen with a different style. A variety of information recognized by the recognition unit 282 may be preset before the user performs the drawing task and/or post-set after the user performs the drawing operation based on implementation.

The recognition unit 282 may create data which can display input drawing patterns based on the recognition result of the drawing pattern. This data may include, without limitation, at least one of data indicating the style or type of pen, colors, thicknesses, time operation was performed, and pattern path data, for example, starting point data, trajectory path data, and ending point data of the drawing pattern. Such data may be delivered to the data processing unit 286 to make a predetermined language, for example, data information described in XML, and details thereof will be described below with reference to FIG. 5.

According to aspects of the invention, there is no specific limitation on algorithms, which may recognize the drawing pattern created by the recognition unit 282. For example, the recognition unit 282 may recognize the drawing pattern by utilizing a touch recognition module and/or a handwriting recognition module provided in the mobile terminal 20. Touch or handwriting recognition algorithms developed and used in the mobile terminal 20, and other touch or handwriting recognition algorithms yet to be developed or used in the mobile terminal 20, may be used to recognize the drawing pattern by the recognition unit 282. The recognition unit 282 may recognize a drawing pattern created by hand or a simple touch pen, by the user, and a drawing pattern created by an electronic touch pen (e.g., Wacom® Touchpen) that may perform a predetermined operation when used.

The recognition unit 282 may recognize the background image used for the drawing task when there is a background image selected by the user. When there is no background image selected by the user, the background image displayed on the mobile terminal 20 may be a default background image provided from corresponding application. The background image may be a picture, a map, which may be a part of a map including a current location of the mobile terminal 20, a graphic stored in the storage unit 24 of the mobile terminal 20, and pictures newly photographed (see FIG. 7D). However, aspects of the invention are not limited thereto, such that the background image may include images captured or downloaded from the Internet, web pages displayed on the display of the mobile terminal and captured images thereof, and stored documents and captured images thereof. The recognition unit 282 may recognize those background images and deliver the corresponding data (e.g., background data) of the recognized background images, or storage location information (e.g., path information) on where the corresponding file or data may be stored to the data processing unit 286.

Moreover, the recognition unit 282 may recognize a change request for an already transmitted drawing pattern, such as the drawing change request. More specifically, the recognition unit 282 may recognize the drawing change request input by detecting a menu selection to request a change or edit (e.g., delete, undo, or redo) the selected unit drawing pattern after the user selects one of the drawing patterns displayed on the touch screen, or by performing the above procedures in reverse order. The recognition unit 282 may deliver information on change requests in addition to identification information on the selected drawing pattern to the data processing unit 286.

The display unit 284 may display the drawing pattern recognized by the recognition unit 282 and/or the background image on the touch screen. When the recognition unit 282 recognizes a change request for an already created drawing pattern, for example, a request to delete, undo, and/or redo, the display unit 284 or the data processing unit 286 may delete or undo the already displayed drawing pattern, or display redoing of the drawing pattern that has been undone or deleted, according to corresponding requests. Further, the display unit 284 or the recognition unit 282 may identify the drawing pattern for which a change has been is requested using identification information (e.g., a drawing ID) included in the drawing information corresponding to an already displayed drawing pattern.

The display unit 284 may also display the drawing information delivered from the data processing unit 286 on the touch screen. The mobile terminal (e.g., the second mobile terminal 20B of FIG. 1) may receive the drawing information transmitted from another mobile terminal (e.g., the first mobile terminal 20A of FIG. 1) and display it on the display. Further, the mobile terminal may receive messages including, for example, drawing information, through the wireless communication unit 26, and drawing information included in the received message may be delivered to the data processing unit 286. The drawing information included in the received message may be, for example, Extensible Markup Language (XML) data illustrated in FIG. 5. The display unit 284 may use drawing data of the drawing information received from the data processing unit 286 to display the corresponding drawing pattern on the touch screen.

When the background data is additionally included in the message received by the mobile terminal 20, or when the background data is received through data communication channel or in a separate message other than the message including the drawing information, the display unit 284 may display the background image corresponding to the background data in addition to the drawing pattern on the touch screen. When the mobile terminal 20 receives messages requesting a change in already transmitted drawing patterns, for example, a request to delete, undo, and redo at least a portion of the transmitted drawing pattern, the display unit 284 may delete or undo at least a portion of the already displayed drawing patterns or display redoing of the drawing pattern that has been undone or deleted according to corresponding requests. The display unit 284 or the recognition unit 282 may identify the drawing pattern that has requested a change using the identification information (e.g., drawing ID) included in the drawing is information corresponding to the already displayed drawing pattern.

The data processing unit 286 may perform an operation of creating a message to be transmitted to another mobile terminal and an operation of parsing the message received from the other mobile terminal for sharing the drawing screen. More specifically, the data processing unit 286 may create one or more messages including, without limitation, at least one of a drawing change request, background data, and drawing information recognized by the recognition unit 282. The data processing unit 286 may parse the message received through the wireless communication unit 26 and deliver, for example, at least one of a drawing change request, background data, drawing data of the drawing information and identification information of target drawing patterns included in the message, to the display unit 284.

According to aspects of the invention, the drawing information included in the message created by the data processing unit 286 may further include, without limitation, resolution information and/or aspect ratio information of the display of the corresponding terminal. Such additional information may support a more accurate sharing operation of the drawing screen, which may consider various differences in the resolution and/or the aspect ratio between displays of two mobile terminals, such as the first mobile terminal 20A and the second mobile terminal 20B, when sharing the drawing screen. The data processing unit 286 or the display unit 284 of the terminal may adjust the drawing pattern by referring to the resolution information and/or the aspect ratio of the terminal itself and other mobile terminal to display an adjusted drawing pattern.

A method of providing a drawing information sharing service according to exemplary embodiments of the invention will be described. The method for providing a drawing information sharing service will be described with reference to various servers of FIG. 1 and the is mobile terminal of FIG. 2, however, aspects of the invention are not limited thereto. Further, aspects of the exemplary method for providing the drawing information sharing service that are not specifically described below may be have been described previously with reference to FIG. 1 and FIG. 2.

FIG. 3 is a flowchart illustrating a procedure in which a service registration is performed with respect to a mobile terminal to provide a drawing information sharing service according to an exemplary embodiment of the present invention.

Although FIG. 3 illustrates the procedure in which only the first mobile terminal 20A registers services in the service providing device 10, aspects of the invention are not limited thereto, such that the second mobile terminal 20B may register services in the service providing device 10 according to the same or similar procedure.

As illustrated in FIG. 3, the first mobile terminal 20A to use the drawing information sharing service transmits a service registration request message to the management server 12 (S31). The service registration request message may include, without limitation, at least one of the phone number and the terminal ID of the first mobile terminal 20A. The phone number and the terminal ID of the first mobile terminal 20A may be an example of mobile terminal information that may be used to identify the first mobile terminal 20A. However, aspects of the invention are not limited thereto, such that other mobile terminal information may be used to perform the same or similar operation as the identification information.

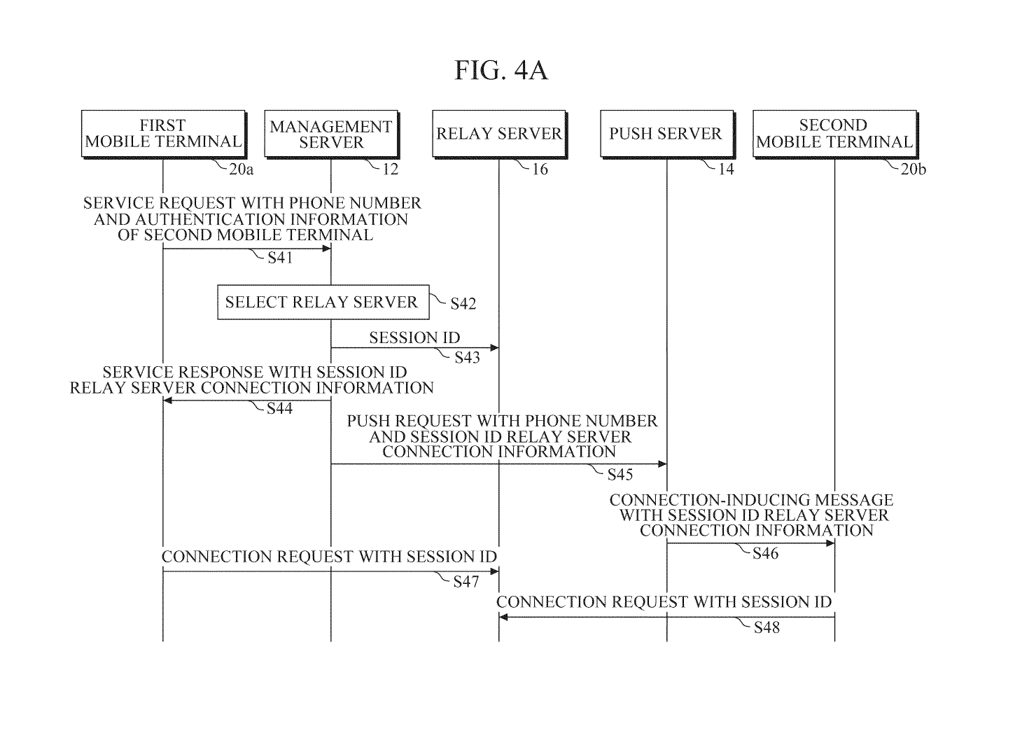

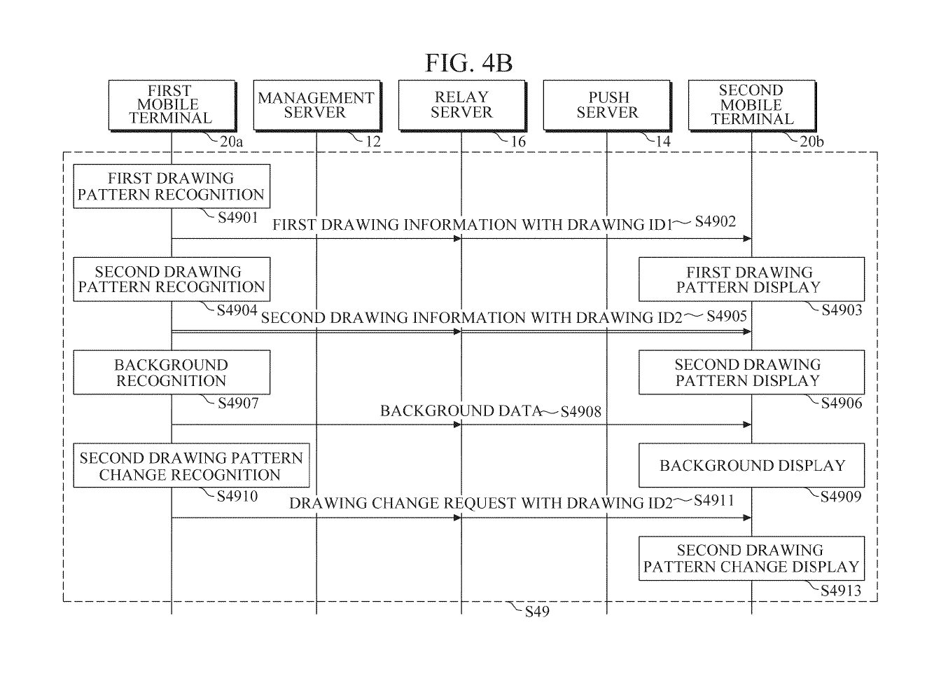

The management server 12 may perform a push registration procedure with respect to the first mobile terminal 20A using received mobile terminal information (S32 and S33). The push registration procedure may allow the registered mobile terminal to receive a push message for the drawing screen sharing service, for example, for receiving transmission is (see S46 of FIG. 4A) of a connection request message, from the push server 14. More specifically, the management server transmits a push registration request message to the push server 14 (S32). The push registration request message may include, without limitation, at least one of a phone number and the terminal ID of the first mobile terminal 20A received in operation S31. In operation S33, the push server 14 receives the push registration request message transmitted in operation S32 and transmits a push registration response message based on the push registration request result to the management server 12.

The management server 12 may inform the service registration status of the first mobile terminal 20A by referring to the push registration result included in the push registration response message received in operation S33. The management server 12 transmits the service registration response message to the first mobile terminal 20A (S34). When the first mobile terminal 20A has registered for the drawing screen sharing service according to operations S32 and S33, authentication information (e.g., a token value having an arbitrary format) to be used in the course of service usage by the first mobile terminal 20A may be included in this service registration response message and delivered to the first mobile terminal 20A. More specifically, the authentication information delivered in operation S34 may be used to authenticate the first mobile terminal 20A by the management server 12 in the course of service usage.

FIG. 4A is a flowchart illustrating a procedure in which two mobile terminals set a wireless data communication link according to an exemplary embodiment of the present invention.

FIG. 4B is a flowchart illustrating a procedure in which two mobile terminals share drawing information over the wireless data communication link set in FIG. 4A according to an exemplary embodiment of the present invention. Although FIG. 4A and FIG. 4B are is illustrated in separate drawings, after the procedure illustrated in FIG. 4A is performed, the procedure in FIG. 4B may be consecutively performed.

In FIG. 4A and FIG. 4B, although the procedure in which the first mobile terminal 20A requests service and the drawing screen of the first mobile terminal 20A is transmitted to the second mobile terminal 20B or changed to share the drawing screen is illustrated, aspects of the invention are not limited thereto. For example, the drawing information sharing service according exemplary embodiments of the invention may be applied when the second mobile terminal 20B requests a service and/or the second mobile terminal 20B wishes to share its own drawing screen with the first mobile terminal 20A, or both the first mobile terminal 20A and the second mobile terminal 20B wish to share their own drawing patterns with another terminal.

As illustrated in FIG. 4A, the first mobile terminal 20A transmits the service request message to the management server 12 (S41). The service request in this operation may be a request for setting the wireless data communication link between the first mobile terminal 20A and the second mobile terminal 20B in order for the first mobile terminal 20A to share the drawing information with the second mobile terminal 20B. Further, the service request message transmitted in operation S41 may include, without limitation, identification information (e.g., phone number) of the second mobile terminal 20B. This service request message may also include the authentication information, for example, a token value, of the first mobile terminal 20A received in operation S34 in FIG. 3.

When the first mobile terminal 20A has been successfully authenticated, the management server 12 receiving the service request message selects a relay server, which may relays data communication between the first mobile terminal 20A and the second mobile is terminal 20B, among a plurality of relay servers provided in the service providing device (S42).

FIG. 4A illustrates only the selected relay server 16 according to selection in operation S42. In FIG. 4B, although a procedure in which the first mobile terminal 20A transmits data to the second mobile terminal 20B through the selected relay server 16 is illustrated, aspects of the invention are not limited thereto, such that the selected relay server 16 may relay two-way data communication between the first mobile terminal 20A and the second mobile terminal 20B.

In operation S42, the management server 12 may select one relay server, which may relay data communication, among the plurality of relay servers, based on a predetermined criterion. For this purpose, although not illustrated in drawings, the management server 12 may investigate a current state (e.g., service providing status (congestion) or network condition) of one or more of the plurality of relay servers provided in the drawing screen sharing system after operation S41, or continue monitoring the state of one or more of the plurality of relay servers in a periodic manner.

The management server 12 may deliver or transmit the wireless data communication link information, for example, session ID, to the relay server 16 selected in operation S42 (S43). The session ID may be used to match the first mobile terminal 20A and the second mobile terminal 20B to be linked when the relay server 16 receives the connection request from each of the first mobile terminal 20A and the second mobile terminal 20B in subsequent operations (S47 and S48).

The management server 12 may transmit the service response message in response to the service request message in operation S41 to the first mobile terminal 20A (S44). When the service request is transmitted by the first mobile terminal 20A in operation S41, the management server 12 may transmit the service response message including the service request is acceptance to the first mobile terminal 20A. The service response message may include, without limitation, at least one of the wireless data communication link information (e.g., session ID) and connection information (e.g., Uniform Resource Locator (URL) of the relay server 16) enabling connection to the relay server 16 selected in operation S42.

The management server 12 transmits a push request message with respect to the second mobile terminal 20B to the push server 14 (S45). The push server 14 may transmit a request message to the second mobile terminal 20B to induce the second mobile terminal 20B to connect to the relay server 16. Accordingly, the push request message may include, without limitation, at least one of wireless data communication link information (e.g., session ID) and connection information on the relay server 16 used in connecting the second mobile terminal 20B to the relay server 16, in addition to the identification information (e.g., phone number) of the second mobile terminal 20B.

The push server 14 receiving the push request message from the management server 12 in operation S45 transmits a push-type connection-inducing message to the second mobile terminal 20B (S46). The push-type connection-inducing message may induce a connection of the second mobile terminal 20B with respect to the relay server 16. The connection request message transmitted in operation S46 may include at least a portion of the data communication link information received in operation S45, for example, the data communication link information (session ID) used for connecting the second mobile terminal 20B with the relay server 16, and/or connection information on the relay server 16.

In FIG. 4A, although operations S43, S44, and S45 are performed sequentially, aspects of the invention are not limited thereto. For example, some or all of operations S43, S44, and S45 may be performed together simultaneously. Further, some or all of operations S43, S44, and S45 may be performed sequentially but in a different order other than illustrated in FIG. 4A.

Further, the first mobile terminal 20A receiving the service response message from the management server 12 in operation S44, and the second mobile terminal 20B receiving the connection-inducing message from the push server 14 in operation S47, each transmit the connection request message to the relay server 16 (S47 and S48). In FIG. 4A, although operations S47 and S48 are illustrated as being performed sequentially, aspects of the invention are not limited thereto, such that operations S47 and S48 may be performed simultaneously or operation S47 may be performed after operation S48.

The connection request message received in each of operations S47 and S48 may include, without limitation, wireless data communication link information (e.g., session ID). The wireless data communication link information may be used by the relay server 16 to match two mobile terminals, such as the first mobile terminal 20A and the second mobile terminal 20B, to relay the wireless data communication. More specifically, the relay server 16 may match the first mobile terminal 20A and the second mobile terminal 20B to be connected using the session ID, which may be included in each of the received connection request messages.

The relay server 16 may set the wireless data communication link between the first mobile terminal 20A and the second mobile terminal 20B that are identified using the session IDs (see S49 of FIG. 4B). Further, the first mobile terminal 20A may transmit messages and/or information used for sharing the drawing screen to the second mobile terminal 20B over the set link. Further, two-way communication can be made between the first mobile terminal 20A and the second mobile terminal 20B. The relay server 16 may maintain the wireless data communication link set between the first mobile terminal 20A and the second mobile terminal 20B. Operation S49 is represented as a dashed block including multiple sub-operations in FIG. 4B.

As illustrated in FIG. 4B, the first mobile terminal 20A recognizes the first drawing pattern, which may be created by the user (S4901). The procedure of recognizing the first drawing pattern in operation S4901 may be performed by the recognition unit 282 of FIG. 2, which may be included in the first mobile terminal 20A. The first mobile terminal 20A transmits information for representing the first drawing pattern. More specifically, the first mobile terminal 20A may transmit the message including the first drawing information, to the second mobile terminal 20B over the set link (S4902). Further, the data processing unit 286 of FIG. 2, which may be included in the first mobile terminal 20A, may create the first drawing information by receiving the data on the first drawing pattern recognized by the recognition unit 282. As described above, the created first drawing information includes identification information (e.g., drawing ID “1”) to identify drawing patterns.

FIG. 5 is a diagram illustrating a message including drawing information according to an exemplary embodiment of the invention.

FIG. 5 illustrates drawing information of a single drawing pattern, however, aspects of the invention are not limited thereto, such that the first drawing information included in the message transmitted from the first mobile terminal 20A to the second mobile terminal 20B in operation S4902 may include drawing information on plurality of unit drawing patterns. Further, the drawing information may include at least items \textcircled{3}, \textcircled{4}, \textcircled{5} and \textcircled{6}. The message illustrated in FIG. 5 may be a message described in XML, however, aspects of the invention are not limited thereto.

As illustrated in FIG. 5, information indicating a type of corresponding message (see item \textcircled{1}) is represented in an upper part of the message. In FIG. 5, “draw” and “/draw” may is indicate that the corresponding message is drawing information. The message may include information on a style of the pen (see item \textcircled{2}), identification information of the corresponding message (see item \textcircled{3}), information on colors and thicknesses of the drawing pattern (see item \textcircled{4}), information on coordinates of lines configuring the drawing pattern (see item \textcircled{5}), and information on a time when the drawing pattern was created (see item \textcircled{6}).

As illustrated in FIG. 4B, the second mobile terminal 20B receiving the message including the first drawing information in operation S4902 displays the first drawing pattern on the touch screen by parsing the received message (S4903). The parsing of the message for displaying the first drawing pattern in operation S4903 may be performed by the data processing unit 286 of FIG. 2, which may be included in the second mobile terminal 20B. Displaying the first drawing pattern on the touch screen using the parsed first drawing information may be performed by the display unit 284 of FIG. 2, which may be included in the second mobile terminal 20B.

In this way, through operations S4901, S4902, and S4903, the first mobile terminal 20A may allow the same drawing pattern as created on its own touch screen to be displayed on the touch screen of the second mobile terminal 20B. Since the background data may not recognized or transmitted through operations S4901, S4902, and S4903, the first drawing pattern may be displayed on each of touch screens of the first mobile terminal 20A and the second mobile terminal 20B, such that there is no background, or default background images provided from the corresponding application or respective mobile terminal are used as the background. Although not illustrated in drawings, in the course of operations S4901, S4902, and S4903 described above, the relay server 16 may transmit and/or receive the control packet to and from the first mobile terminal 20A and the second mobile terminal 20B in a periodic or a non-periodic manner in the application layer, so that the relay server 16 may additionally check whether the network connection is maintained between the first mobile terminal 20A and the second mobile terminal 20B.

Further, the first mobile terminal 20A transmits and shares the second drawing pattern, other than the first drawing pattern, to the second mobile terminal 20B (S4904, S4905, and S4906). Although operations S4904, S4905, and S4906 are illustrated as being performed after operation S4903, aspects of the invention are not limited thereto. For example, a procedure to change or transmit the background image (see S4907, S4908, and S4909), or a procedure to change the already transmitted first drawing pattern, may be performed after operation S4903. In addition, a procedure in which the second mobile terminal 20B creates and transmits a new drawing pattern to the first mobile terminal 20A, or a procedure in which the second mobile terminal 20B changes the first drawing pattern displayed on the display, may be performed.

In order to transmit the second drawing pattern, the first mobile terminal 20A recognizes the second drawing pattern created by the user (S4904). The recognizing of the second drawing pattern in operation S4904 may also be performed by the recognition unit 282 of FIG. 2, which may be included in the first mobile terminal 20A. The first mobile terminal 20A transmits information for displaying the second drawing pattern, more specifically, the message including the second drawing information, to the second mobile terminal 20B over the set link (S4905). According to aspects of the invention, the data processing unit 286 of FIG. 2, which may be included in the first mobile terminal 20A, may create the second drawing information by receiving the data related to the second drawing pattern recognized by the recognition unit 282. The created second drawing information created may include unique identification information (e.g., drawing ID “2”) to identify the drawing pattern.

The second mobile terminal 20B receiving the message including the second drawing information in operation S4905 displays the second drawing pattern on the touch screen by parsing the received message (S4906). The parsing of the message for displaying the second drawing pattern in operation S4906 may be performed by the data processing unit 286 of FIG. 2, which may be included in the second mobile terminal 20B. The displaying of the second drawing pattern on the touch screen using the parsed second drawing information may be performed by the display unit 284 of FIG. 2, which may be included in the second mobile terminal 20B.

Operations S4904, S4905, and S4906 in FIG. 4B illustrate that the first mobile terminal 20A additionally transmits the second drawing pattern other than the first drawing pattern to the second mobile terminal 20B. All or a part of the second drawing information related to the second drawing pattern, which is additionally transmitted, may differ from the first drawing information in terms of a pen type, colors, thicknesses, coordinates of lines, and a time when the drawing pattern was created. According to aspects of the invention, the pen type included in the second drawing information may be an eraser. Further, all or a part of the line coordinates may be the same as in the first drawing information. In operation S4906, all or some of the first drawing pattern displayed on the touch screen of the second mobile terminal 20B in operation S4903 may be erased or appear to be erased.

A procedure in which the first mobile terminal 20A transmits and shares a new background image to the second mobile terminal 20B is performed (see operations S4907, S4908, and S4909). Although operations S4907, S4908, and S4909 are illustrated as being performed after operation S4906, aspects of the invention are not limited thereto. For example, operations S4907, S4908, and S4909 may be performed before operation S4901, before is operation S4904, or after operation S4912 described below. Further, one or more of operations S4907, S4908, and S4909 may be performed simultaneously with all or some of operations S4901, S4902, S4903, S4904, S4905, and S4906, or all or some of operations S4910, S4911, and S4912.

In the procedure of transmitting the background data (e.g., operation S4908) to share the background image, the background data may be transmitted over the same channel as the drawing information or over a separate channel. In the latter case, at least two transmission channels may be assigned between the first mobile terminal 20A and the second mobile terminal 20B. The drawing information may be a small amount of data and the background image may be a larger amount of data. A transmission channel having a smaller transmission capacity may be assigned for transmission of the drawing information and a transmission channel having a larger transmission capacity may be assigned for transmission of the background data. In this way, it may be possible to reduce a likelihood of delay in transmission of the drawing information from the first mobile terminal 20A to the second mobile terminal 20B and the background data may be more rapidly transmitted.

In order to transmit the background data, the first mobile terminal 20A recognizes a background change request from the user (S4907). The user of the first mobile terminal 20A may touch or select a background change menu (e.g., a graphic menu having a shape of mountain displayed in the third in the upper menu box in FIG. 7D) displayed as a UI or an icon on the touch screen to request to change the background image. The user may select a type of the background image and a specific background image to be newly used with a UI or an icon (e.g., a menu for selecting a background image type in FIG. 7D) displayed according to the touch or selection of the background change menu.

The change request of the background image and the procedure of recognizing the background image to be changed in operation S4907 may also be performed by the recognition unit 282 of FIG. 2, which may be included in the first mobile terminal 20A. The first mobile terminal 20A transmits the message in which the background data corresponding to the background image to be used or changed is included to the second mobile terminal 20B over the set link (S4908). The data processing unit 286 of FIG. 2, which may be included in the first mobile terminal 20A may receive information (e.g., a file path of the background image stored in the storage unit 24) on the background image recognized by the recognition unit 282 and may create the message including the background data.

The second mobile terminal 20B receiving the message including the background data in operation S4908 displays the background image on the touch screen by parsing the received message (S4909). The parsing of the message for displaying the background image in operation S4909 may be performed by the data processing unit 286 of FIG. 2, which may be included in the second mobile terminal 20B. Displaying the background image on the touch screen using the parsed background data may be performed by the display unit 284 of FIG. 2, which may be included in the second mobile terminal 20B.

Operations S4907, S4908, and S4909 in FIG. 4B illustrate a procedure in which the first mobile terminal 20A transmits the background data for displaying the background image other than the existing background to the second mobile terminal 20B. The background image transmitted in operations may be an image, for example, the picture stored in the storage unit 24 of FIG. 2, or a map for the predetermined area (e.g., a map including a location of the first mobile terminal 20A). However, aspects of the invention are not limited thereto, such that a variety images or files may be used as the background.

A procedure in which the first mobile terminal 20A may change the second drawing pattern, which may already be transmitted to the second mobile terminal 20B, and share the changed second drawing pattern with the second mobile terminal 20B, may be performed (see operations S4910, S4911, and S4912). Although operations S4910, S4911, and S4912 are illustrated as being performed after operation S4909, aspects of the invention are not limited thereto. For example, at least one of the operations S4910, S4911, and S4912 may be performed independently from at least one of the operations S4907, S4908, and S4909. Moreover, before operation S4910, at least one of a procedure to share the third drawing information, a procedure to change already transmitted first drawing pattern, and a procedure to change the background image may also be performed.

The change of the drawing pattern performed in this procedure may include a change of the overall unit drawing pattern. For example, the change of the drawing pattern may include deletion of the drawing pattern (e.g., the first drawing pattern and/or the second drawing pattern) which may be created in the first mobile terminal 20A and shared with the second mobile terminal 20B, or undoing the drawing pattern (e.g., the second drawing pattern) which may be created and shared previously. Moreover, the change of the drawing pattern may include re-executing the drawing pattern which was deleted or undone.

In order to change the second drawing pattern, the first mobile terminal 20A recognizes the change request and a type of change for the second drawing pattern, which may be selected by a user (operation S4910). A procedure for recognizing the change request for the second drawing pattern in operation S4910 may be performed by the recognition unit 282 of FIG. 2, which may be included in the first mobile terminal 20A. The first mobile terminal 20A transmits the message including information on requesting the change of the already transmitted is second drawing pattern, for example, deletion or undoing, to the second mobile terminal 20B over the set link (operation S4911). The data processing unit 286 of FIG. 2, which may be included in the first mobile terminal 20A, may receive the change request of the second drawing pattern recognized by the recognition unit 282 and create the message including the change request for the second drawing pattern.

The change request of the drawing pattern included in the message transmitted in this operation may include identification information (e.g., drawing ID “2”) to identify the second drawing pattern and commands to indicate the type of the change. Since the change of the drawing pattern may be performed on one or more drawing pattern units, it may be possible to specify the drawing pattern to be changed with some sort of identification information associated with the drawing pattern (e.g., drawing ID) which can identify the corresponding drawing pattern unit. Further, the change request of the drawing pattern may not include information on, for example, the pen type or style, colors of patterns, thicknesses, and coordinates of lines, however, aspects of the invention are not limited thereto.

The second mobile terminal 20B, which has received the message including the drawing change request for the second drawing pattern in operation S4911, deletes or undoes the second drawing pattern displayed on the touch screen by parsing the received message (S4912). The parsing of the message for changing the second drawing pattern in operation S4912 may be performed by the data processing unit 286 of FIG. 2, which may be included in the second mobile terminal 20B. Deleting or undoing the second drawing pattern displayed on the touch screen using the parsed change request and the drawing ID may be performed by the display unit 284 of FIG. 2, which may be included in the second mobile terminal 20B.

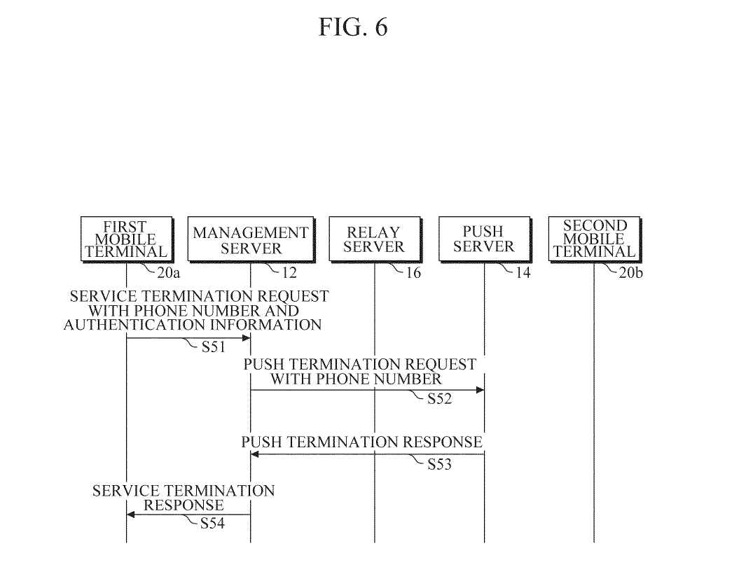

FIG. 6 is a flowchart illustrating a procedure for terminating a service registration is on a mobile terminal according to an exemplary embodiment of the present invention. Similar to FIG. 3, although FIG. 6 illustrates a procedure in which only the first mobile terminal 20A terminates the service, aspects of the invention are not limited thereto, such that the second mobile terminal 20B may also perform the service termination according the same or similar procedure as the first mobile terminal 20A. A mobile terminal may perform service terminal in response to a user's request or according to service policy.

As illustrated in FIG. 6, when the mobile terminal 20A that has registered for the service according to the procedure in FIG. 3 wishes to stop the drawing information sharing service, a service termination request message is transmitted to the management server 12 (S51). The service termination request message may include authentication information in addition to the phone number of the mobile terminal 20A. The phone number of the mobile terminal 20A may be an example of the mobile terminal information that may be used to identify the mobile terminal 20A. However, aspects of the invention are not limited thereto, such that other mobile terminal information may be used as the identification information to perform the same operation. Moreover, the authentication information may be the same or similar as the authentication information received in operation S34 in FIG. 3 by the first mobile terminal 20A, however, aspects of the invention are not limited thereto.

The management server 12 performs a push termination procedure for the mobile terminal 20A using the received mobile terminal information (S52 and S53). In an example, the push termination procedure may be used to delete information on the first mobile terminal 20A that may have been registered in the push server 14 to use the push service in operations S32 and S33 of FIG. 3. Further, the management server 12 transmits the push termination request message to the push server 14 (S52). The push termination request message may include is identification information, for example, the phone number of the first mobile terminal 20A received in operation S51. The push server 14 receiving the push termination request message transmits the push termination response message based on the push termination request result to the management server 12 (S53). The management server 12 outputs the service termination request processing result of the first mobile terminal 20A by referring to the push termination result included in the push termination response message received in operation S53. The management server 12 may transmit the service termination response message to the first mobile terminal 20A (S54).

According to the exemplary embodiments described above, data transmission operation between mobile terminals to share a drawing screen may be performed over a data communication channel, which may be set and maintained. The mobile terminal may transmit a drawing pattern created by a user to another mobile terminal serving as a peer terminal, independently from progress of a voice or video call. In addition, various background images in addition to the drawing pattern may be transmitted separately from the drawing pattern over a separate channel, such that the mobile terminal may share the drawing screen with the peer terminal. Further, the background images may be transmitted at a high transmission rate to share the drawing screen with the peer terminal in real time. Drawing information to be transmitted to the peer terminal may include identification information to identify the drawing pattern, such that it may be possible to delete or undo a drawing pattern that has already been transmitted to others, or to redo the drawing pattern once deleted or undone. Moreover, the mobile terminal may correct the drawing pattern created or transmitted by the user and/or the drawing pattern received from the peer terminal.

Aspects of the present invention can be implemented as computer readable codes in a computer readable record medium. The computer readable record medium may include some or all types of record media in which computer readable data may be stored. Examples of the computer readable record medium may include, without limitation, a ROM, a RAM, a compact disc read only memory (CD-ROM), a magnetic tape, a floppy disk, and an optical data storage. Further, the record medium may be implemented in the form of a carrier wave, such as Internet transmission. In addition, the computer readable record medium may be distributed to computer systems over a network, in which computer readable codes may be stored and executed in a distributed manner.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for sharing a drawing screen, comprising:
establishing a data communication link between a first mobile terminal and a second mobile terminal using data communication link information; and
sharing of a drawing screen of the first mobile terminal with the second mobile terminal using the data communication link.

2. The method of claim 1, wherein the establishing the data communication link comprises:
transmitting, to a management server by the first mobile terminal, a service request for connecting with the second mobile terminal;
selecting a relay server for relaying data between the first mobile terminal and the second mobile terminal;
generating and transmitting, by the management server, the data communication link information to the relay server and the first mobile terminal;
transmitting, to a push server by the management server, a push request message for connecting with the second mobile terminal; and
transmitting, by the push server, a connection-inducing message comprising at least a portion of the data communication link information.

3. The method of claim 1, wherein the data communication link information comprises a session identification (ID).

4. The method of claim 2, wherein the establishing the data communication link further comprises:
registering identification information of the first mobile terminal with the management server and the push server.

5. The method of claim 4, wherein the identification information comprises at least one of a phone number and a terminal identifier of the first mobile terminal.

6. The method of claim 1, wherein the sharing of the drawing screen comprises:
recognizing generation of a first drawing pattern; and
transmitting, by the first mobile terminal, first drawing information to the second mobile terminal,
wherein the first drawing information comprises data corresponding to the first drawing pattern.

7. The method of claim 6, wherein the sharing of the drawing screen further comprises:
transmitting, by the first mobile terminal, background data to the second mobile terminal.

8. The method of claim 6, wherein the first drawing information comprises a drawing ID corresponding to the first drawing pattern.

9. The method of claim 7, wherein the first drawing information and the background data are transmitted, by the first mobile terminal, through separate channels.

10. The method of claim 7, wherein background of the second mobile terminal is replaced with the background data.

11. The method of claim 8, further comprising:
identifying the first drawing pattern using the drawing ID; and
editing the identified first drawing pattern.

12. The method of claim 1, further comprising:
terminating the sharing of the drawing screen of the first mobile terminal with the second mobile terminal.

13. The method of claim 1, further comprising:
simultaneously performing a voice calling operation by at least one of the first mobile terminal and the second mobile terminal.

14. The method of claim 1, wherein the drawing screen of the first mobile terminal is shared with the second mobile terminal in real time.

15. A first mobile terminal to share a drawing screen, comprising:
a wireless communication unit to establish a data communication link with a second mobile terminal using data communication link information received from a management server storing registration information of at least one of the first mobile terminal and the second mobile terminal; and
a controller to share a drawing screen displayed on the first mobile terminal with the second mobile terminal using the data communication link.

16. The first mobile terminal of claim 15, wherein the drawing screen of the first mobile terminal is shared with the second mobile terminal in real time.

17. The first mobile terminal of claim 15, wherein the controller recognizes generation of a first drawing pattern and transmits, to the second mobile terminal, first drawing information comprising data corresponding to the first drawing pattern.

18. The first mobile terminal of claim 17, wherein the first drawing information comprises a drawing identification (ID) corresponding to the first drawing pattern.

19. The first mobile terminal of claim 18, wherein the controller identifies the first drawing pattern using the drawing ID and edits the identified first drawing pattern.

20. A system to share a drawing screen of a first mobile terminal with a second mobile terminal, comprising:
a management server to receive a request for sharing a drawing screen from the first mobile terminal, to select a relay server for relaying data between the first mobile terminal and the second mobile terminal, to transmit data communication link information to the relay server and the first mobile terminal, to transmit a push request message for connecting with the second mobile terminal to a push server;
the push server to transmit, to the second mobile terminal, a connection-inducing message comprising at least a portion of the data communication link information; and
the relay server to establish a connection between the first mobile terminal and the second mobile terminal according to the data communication link information for sharing the drawing screen of the first mobile terminal with the second mobile terminal.
